(19) United States
(12) Patent Application Publication
(10) Pub. No.: US 2003/0176099 A1
(43) Pub. Date: Sep. 18, 2003

(54) Insulation-piercing connecting device

(76) Inventors: Wolfgang Brandl, Amberg (DE); Peter Donhauser, Amberg (DE); Alfred Fisher, Schwandorf (DE); Ludwig Niebler, Laaber (DE)

Correspondence Address: HARNESS, DICKEY & PIERCE, P.L.C., P.O.BOX 8910, RESTON, VA, 20195, US

(21) Appl. No.: 10/344,155

(22) PCT Filed: Jul. 30, 2001
(86) PCT No.: PCT/DE01/02882

(30) Foreign Application Priority Data
Aug. 10, 2000 (DE) 100 39 202.4

(51) Int. Cl. H01R 4/24

(52) U.S. Cl. 439/395

(57) ABSTRACT

The invention relates to an insulation-piercing connecting device comprising a connecting device housing (1) containing an insulation-piercing connector (11) that can be actuated by a screw (2). The insulation-piercing connector (11) allows an insulated conductor (13) that has not been stripped to be clamped. Additionally or alternatively, the screw (2) can be used to clamp at least one other conductor (7, 8, 13′).

The present invention relates to an insulation-piercing connecting device with a connecting device housing and an insulation-piercing connector which is arranged in the connecting device housing, can be actuated by means of an actuating element and by means of which an insulated conductor that has not been stripped can be clamped.

An insulation-piercing connecting device of this type is known for example from DE 197 32 182 C1.

In the prior art, the insulation-piercing connector can be pressed together, for example by means of levers which are pivoted. This requires both a comparatively large actuating space and comparatively high actuating forces. Furthermore, with the insulation-piercing connecting devices of the prior art, generally only a single conductor can be clamped. If a number of conductors are to be clamped, a number of interconnected insulation-piercing connecting devices are required.

In the older German patent application 199 44 312.2, which was not published before the priority date, there is a description of an insulation-piercing connecting device with a connecting device housing and an insulation-piercing connector which is arranged in the connecting device housing, can be actuated by means of a screw and by means of which an insulated conductor that has not been stripped can be clamped.

The object of the present invention is to provide a compact insulation-piercing connecting device which can be actuated by little force and by means of which nevertheless a number of conductors can be clamped.

The object is achieved by the actuating element being formed as a screw and the screw allowing at least one further conductor to be additionally or alternatively clamped.

This is because actuation then only requires a screwdriver to be applied and turned. This mode of actuation, which is generally known in the case of screw-type terminals, by means of which stripped insulated conductors are clamped, requires only little space. On account of the conversion of the rotational movement of the screwdriver into an axial movement, furthermore, only low actuating forces are required.

If the insulation-piercing connecting device has a further insulation-piercing connector for clamping the further conductor, both conductors can be clamped without prior cutting to length and stripping.

If the screw has a screw head and the further conductor can be clamped in a stripped form by means of the screw head and a counterbearing, the insulation-piercing connecting device according to the invention is particularly flexible.

This is because a conductor which has a preferred conductor cross section can be clamped in the insulation-piercing connector without stripping. In the screw-type terminal, on the other hand, up to two stripped conductors can be clamped, it being possible for the conductor cross section of these two conductors to differ considerably from that of the conductor which is fastened or can be fastened in the insulation-piercing connector. The cross sections of the two stripped conductors may even deviate significantly from each other. It goes without saying that this configuration is particularly advantageous additionally for the further insulation-piercing connector.

If, with the stripped conductor clamped, a roof-type washer is arranged between the screw head and the stripped conductor, the clamping of the stripped conductors is particularly reliable. This applies most particularly whenever the roof-type washer is formed in a V-shaped manner.

If the counterbearing is arranged between the screw head and the insulation-piercing connector, a particularly compact form of construction is obtained.

If the screw interacts with the insulation-piercing connector via a connecting web with a connecting web width, the insulation-piercing connecting device is structurally of a particularly simple design.

If the screw has a screw neck with a screw neck thickness and the connecting web width is approximately equal to the screw neck thickness, the connecting web does not result in a restriction with respect to the conductor cross sections of the conductors which are introduced or can be introduced into the insulation-piercing connector.

The screw may be mounted in the connecting device housing either in an axially displaceable manner or—at least substantially—in an axially undisplaceable manner.

With axially undisplaceable mounting of the screw, the insulation-piercing connecting device has a frame body which is mounted in the connecting device housing in an axially displaceable manner and into which the screw can be screwed. The insulation-piercing connector is in this case actuated by means of an actuating element which engages in an axially undisplaceable manner in a recess in the frame body and is connected rigidly—preferably integrally—to the insulation-piercing connector.

Further advantages and details emerge from the following description of an exemplary embodiment in conjunction with the drawings, in which, in basic representation,

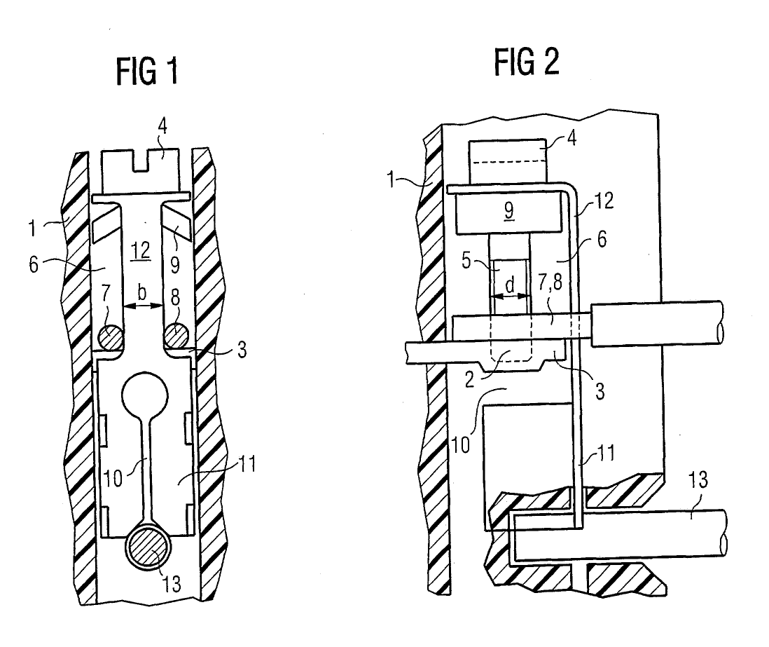

FIG. 1 shows an insulation-piercing clamping device in section from the front,

FIG. 2 shows the insulation-piercing connecting device from FIG. 1 from the side,

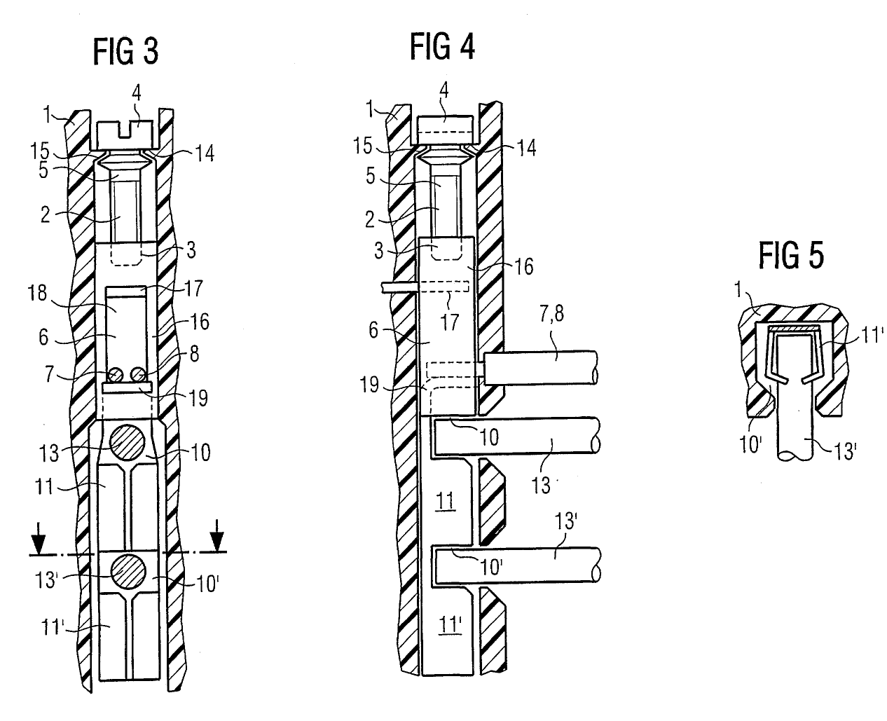

FIG. 3 shows a further insulation-piercing connecting device from the front,

FIG. 4 shows the insulation-piercing connecting device from FIG. 3 from the side and

FIG. 5 shows the insulation-piercing connecting device from FIG. 3 from above.

According to FIGS. 1 and 2, an insulation-piercing connecting device has a connecting device housing 1. Arranged in the connecting device housing 1 is a screw 2, which can be screwed into a counterbearing 3. According to FIGS. 1 and 2, the counterbearing 3 is fixed to the housing. The screw 2 has a screw head 4 and a screw neck 5. The screw neck 5 has a screw neck thickness d.

The screw head 4 and the counterbearing 3 define an insulation-piercing connector space 6, in which up to two stripped individual conductors 7, 8, for example stripped cable cores 7, 8, can be clamped. The clamping takes place in this case by means of a V-shaped roof-type washer 9, which is arranged between the stripped conductors 7, 8 and the screw head 4.

Arranged in the connecting device housing 1 underneath the counterbearing 3 is an insulation-piercing connector space 10, with an insulation-piercing connector 11. The insulation-piercing connector 11 can likewise be actuated by means of the screw 2. The screw 2 in this case interacts with the insulation-piercing connector 11 via a connecting web 12. The connecting web 12 has a connecting web width b. The connecting web width b is approximately equal to the screw neck thickness d. The permissible cross sections of the stripped conductors 7, 8 are consequently determined—as in the case of a customary screw-type terminal—by the dimensions of the connecting device housing 1 and the screw neck thickness d, but are not restricted by the connecting web width b.

As the term “insulation-piercing connector” suggests, an individual insulated conductor 13 that has not been stripped can be clamped and consequently also contacted by means of the insulation-piercing connector 11. The clamping of the non-stripped conductor 13 can in this case take place in addition to or as an alternative to the clamping of the stripped conductor 7 or 8 or of the stripped conductors 7 and 8. It is thus optionally possible to clamp one, two or all three of the conductors 7, 8, 13.

According to FIGS. 1 and 2, the screw 2 is mounted in an axially displaceable manner in the connecting device housing 1. However, as represented in FIGS. 3 and 4, it may also be mounted—at least substantially—in an axially undisplaceable manner.

In this case, the connecting device housing 1 has bearing points 14, 15, which restrain axial displaceability of the screw 2. Furthermore, the insulation-piercing connecting device has a frame body 16, into which the screw 2 can be screwed. The frame body 16 is mounted in an axially displaceable manner in the connecting device housing 1. When the frame body 16 is displaced, it presses the stripped conductors 7, 8 against a contact tongue 17 and consequently clamps them.

The frame body 16 also has a recess 18. The recess 18 is widened—at least slightly—in its lower region. An actuating element 19 engages in the recess 18 and, as a result, is mounted in the recess 18 in an axially undisplaceable manner. The actuating element 19 is connected integrally, and consequently in particular rigidly, to the insulation-piercing connector 11. Together with the displacement of the frame body 16, the insulation-piercing connector 11 is consequently also actuated. In the case of the embodiment according to FIGS. 3 and 4—see also FIG. 5—said insulation-piercing connector is designed as a tubular contact.

Otherwise, the insulation-piercing connecting device according to FIGS. 3 to 5 corresponds substantially to the insulation-piercing connecting device according to FIGS. 1 and 2. It merely has in addition to the insulation-piercing connector space 6 and the insulation-piercing connector space 10 a further insulation-piercing connector space 10′, in which a further insulation-piercing connector 11′ is arranged. A further non-stripped individual conductor 13′ can be clamped and consequently also contacted by means of the further insulation-piercing connector 11′. Consequently, the insulation-piercing connecting device according to FIGS. 3 and 4 allows up to four individual conductors 7, 8, 13 and 13′ to be clamped in any desired combination.

It goes without saying that the design of the insulation-piercing connecting device with two insulation-piercing connectors 11, 11′ is not restricted to the embodiment according to FIGS. 3 to 5, but in principle can also be realized in the case of the embodiment according to FIGS. 1 and 2.

The insulation-piercing connecting device according to the invention has many advantages. In particular, it is possible in the case of an appliance that is provided with the insulation-piercing connecting device according to the invention for the type of clamping of a conductor 7, 8 or 13 (if appropriate, also the conductor 13′) only to be established on site. Furthermore, the insulation-piercing connector 11 allows a non-stripped conductor 13 (if appropriate, the insulation-piercing connectors 11, 11′ even allow two non-stripped conductors 13, 13′) in the most frequently occurring cross-sectional range—for the respective appliance—to be immediately clamped without stripping. On the other hand, a great cross-sectional range of the conductors 7, 8 can be covered by means of the screwing-clamping connection. Furthermore, up to three or four conductors 7, 8, 13, 13′ can be clamped.

The actuating of the insulation-piercing connecting device requires only low forces and a small actuating space. This is because a screwdriver merely has to be turned about its longitudinal axis, but not pivoted transversely thereto. Also, relatively small forces are transferred from the connecting device housing 1 to an appliance fastening, by means of which an appliance in which the insulation-piercing connecting device according to the invention is arranged is fastened, for example on a supporting rail.

1. An insulation-piercing connecting device with a connecting device housing (1) and an insulation-piercing connector (11) which is arranged in the connecting device housing (1), can be actuated by means of a screw (2) and by means of which an insulated conductor (13) that has not been stripped can be clamped, the screw (2) allowing at least one further conductor (7, 8, 13′) to be additionally or alternatively clamped.

2. The insulation-piercing connecting device as claimed in claim 1, characterized in that it has a further insulation-piercing connector (11′) for clamping the at least one further conductor (13′).

3. The insulation-piercing connecting device as claimed in claim 1 or 2, characterized in that the screw (2) has a screw head (4) and in that the at least one further conductor (7, 8) can be clamped in a stripped form by means of the screw head (4) and a counterbearing (3).

4. The insulation-piercing connecting device as claimed in claim 3, characterized in that, with the stripped conductor (7, 8) clamped, a roof-type washer (9) is arranged between the screw head (4) and the stripped conductor (7, 8).

5. The insulation-piercing connecting device as claimed in claim 4, characterized in that the roof-type washer (9) is formed in a V-shaped manner.

6. The insulation-piercing connecting device as claimed in claim 3, 4 or 5, characterized in that the counterbearing (3) is arranged between the screw head (4) and the insulation-piercing connector (11).

7. The insulation-piercing connecting device as claimed in claim 6, characterized in that the screw (2) interacts with the insulation-piercing connector (11) via a connecting web (12) with a connecting web width (b).

8. The insulation-piercing connecting device as claimed in claim 7, characterized in that the screw (2) has a screw neck (5) with a screw neck thickness (d) and in that the screw web width (b) is approximately equal to the screw neck thickness (d).

9. The insulation-piercing connecting device as claimed in one of the above claims, characterized in that the screw (2) is mounted in the connecting device housing (1) in an axially displaceable manner.

10. The insulation-piercing connecting device as claimed in one of the above claims, characterized in that the screw (2) is mounted in the connecting device housing (1) in an axially undisplaceable manner.

11. The insulation-piercing connecting device as claimed in claim 10, characterized in that it has a frame body (16) which is mounted in the connecting device housing (1) in an axially displaceable manner and in that the screw (2) can be screwed into the frame body (16).

12. The insulation-piercing connecting device as claimed in claim 11, characterized in that the frame body (16) has a recess (18) and in that an actuating element (19) for the insulation-piercing connector (11) engages in the recess (18) in an axially undisplaceable manner, the actuating element (19) being connected rigidly—preferably integrally—to the insulation-piercing connector
